(19) United States
(12) Patent Application Publication
(10) Pub. No.: US 2023/0122765 A1
(43) Pub. Date: Apr. 20, 2023

(54) DISPLAY PANEL AND BRIGHTNESS COMPENSATION METHOD THEREOF

(71) Applicant: HUIZHOU CHINA STAR OPTOELECTRONICS DISPLAY CO., LTD., Huizhou, Guangdong (CN)

(72) Inventors: Zhaohong FU, Huizhou, Guangdong (CN); Xinying LUO, Huizhou, Guangdong (CN); Guoqing GAO, Huizhou, Guangdong (CN); Huaiyu WANG, Huizhou, Guangdong (CN)

(21) Appl. No.: 17/615,154

(22) PCT Filed: Nov. 11, 2021
(86) PCT No.: PCT/CN2021/130067

§ 371 Date: Nov. 30, 2021

(30) Foreign Application Priority Data
Oct. 19, 2021 (CN) 202111213483.X

(51) Int. Cl. G09G 3/3233

(52) U.S. Cl. CPC G09G 3/3233; G09G 2300/0842; G09G 2360/147; G09G 2320/0233; G09G 2360/16; G09G 2330/021

(57) ABSTRACT

The present application provides a display panel and a brightness compensation method thereof. Multiple sub-pixel units in each pixel unit share the same sensing unit, and the normal display process and optical inspection process of each pixel unit are carried out separately, so as to make each sub-pixel unit reach the target brightness. As a result, the number of sensing units in the optical compensation system could be reduced; the manufacturing process of the display panel could be simplified, and the manufacturing cost of the display panel could be reduced.

### FIELD OF INVENTION

The present invention relates to the field of display technology, in particular to a display panel and a brightness compensation method thereof.

### BACKGROUND OF INVENTION

Organic light-emitting display diodes (OLED) as a current-type light-emitting device have been increasingly used in high-performance displays. OLED can be divided into Passive Matrix OLED (PMOLED) and Active Matrix OLED (AMOLED) according to the driving mode, namely direct addressing and the thin film transistor (TFT) matrix addressing. Wherein, the PMOLED, as the display size increases, requires a shorter driving time for a single pixel, so as to increase the transient current and increase the power consumption; at the same time, the application of high current will cause the voltage over-drop on the ITO line and the operating voltage of the OLED goes too high, reducing its efficiency. In the other hand, the AMOLED scans the OLED current line by line through the switch tube, which can solve above problems well.

However, the AMOLED display panels may also cause current differences due to the uneven process of thin film transistors or threshold voltage drift, IR drop caused by the capacitive and resistive load of the backplane power line, the uneven electrical characteristics caused by the uneven film thickness during evaporation of the OLED light-emitting device, so that the brightness of each pixel is different, and the display is uneven (mura) or has after-image. Therefore, AMOLED display panels generally integrate an optical compensation system to measure the brightness of each pixel to adjust the brightness of each pixel to be consistent; however, in the current optical compensation system, each optical sensor corresponds to only one sub-pixel unit; as the size of the display panel increases, the number of pixels increases sharply; thus, that will lead to a sharp increase in the number of optical sensors required, making the manufacturing process of the display panel complicated and increasing the cost.

Therefore, there is an urgent need for a display panel and a brightness compensation method thereof to minimize the number of optical sensors in the optical compensation system, simplifying the manufacturing process of the display panel and reducing the cost.

### SUMMARY OF INVENTION

In the current optical compensation system, each optical sensor corresponds to only one sub-pixel unit; as the size of the display panel increases, the number of pixels increases sharply; thus, that will lead to a sharp increase in the number of optical sensors required, making the manufacturing process of the display panel complicated and increasing the cost.

In order to solve the above problems, the technical solutions provided by the application are as follows.

In the first aspect, an embodiment of the present invention provides a display panel, which comprises a plurality of pixel units arranged in an array, wherein each of the pixel units comprises a plurality of sub-pixel units; and a plurality of sensing units, wherein the sub-pixel units of each of the pixel units are respectively connected to the same sensing unit; wherein each of the sensing units is used to measure an actual brightness of each of the sub-pixel units in the corresponding pixel unit and is used to perform a brightness compensation on each of the sub-pixel units according to the actual brightness so as to make each of the sub-pixel units reaches a target brightness.

In some embodiments, each of the sub-pixel units includes a first thin film transistor (TFT), a second TFT, a third TFT, a first storage capacitor, and an organic light emitting diode (OLED); wherein a gate of the first TFT is respectively connected to a drain of the second TFT and a first end of the first storage capacitor; a source of the first TFT is connected to a positive electrode of the power supply; a drain of the first TFT is connected to a second end of the first storage capacitor, an anode of the OLED, and a source of the third TFT; a cathode of the OLED is connected to a negative electrode of the power supply; a gate of the second TFT and a gate of the third TFT are connected to a first scan line; a source of the second TFT is connected to a data line; and a drain of the third TFT is connected to a sensing line.

In some embodiments, the sensing unit includes a fourth TFT, a photodiode, and a second storage capacitor; wherein a gate of the fourth TFT is connected to a second scan line, a drain of the fourth TFT is connected to the sensing line, a source of the fourth TFT is connected to a first end of the photodiode, a second end of the photodiode is connected to a control line, and a first end of the second storage capacitor is connected to the sensing line.

In some embodiments, the sensing unit further includes a compensation module, which is connected to a second end of the second storage capacitor and is configured to adjust the data voltage provided from the data line to the sub-pixel unit according to the actual brightness of the sub-pixel unit, so as to make the sub-pixel unit reach the target brightness.

In some embodiments, the OLED includes an organic light emitting layer. Wherein the photodiode is disposed between the organic light emitting layer and a TFT array, and the organic light emitting layer emits light to the photodiode.

In some embodiments, the display panel is an OLED display panel.

In the second aspect, the embodiment of the present invention also provides a brightness compensation method of a display panel, comprising: emitting light sequentially by sub-pixel units in each pixel unit on a time gap between the frame images displayed by the display panel and measuring the actual brightness of each sub-pixel unit in the corresponding pixel unit by the sensing unit; and performing brightness compensation on each sub-pixel unit according to the actual brightness of each sub-pixel unit measured by the sensing unit, so as to make each sub-pixel unit reach the target brightness.

In some embodiments, the emitting light sequentially by sub-pixel units in each pixel unit and measuring the actual brightness of each sub-pixel unit in the corresponding pixel unit by the sensing unit, specifically comprising: emitting light sequentially by one of the sub-pixels in each pixel unit and measuring the actual brightness of one of the sub-pixel units by the sensing unit corresponding to the pixel unit.

In some embodiments, the performing brightness compensation on each sub-pixel unit according to the actual brightness of each sub-pixel unit measured by the sensing unit, so as to make each sub-pixel unit reach the target brightness, specifically comprising: calculating a difference between the actual brightness and the target brightness of each sub-pixel unit by the compensation module, and adjusting a data voltage provided from the data line to each sub-pixel unit, so as to make the actual brightness of each sub-pixel unit reach the target brightness.

In some embodiments, the displaying frame images by the display panel, specifically comprising: in a reset phase, turning on the first scan line to turn on the second TFT and the third TFT and to reset potentials of the first terminal and the second terminal of the first storage capacitor; in the write phase, writing a data signal through the data line to turn on the first TFT and to charge the first storage capacitor; and in the light emitting phase, keeping the first TFT turning on by the coupling effect of the first storage capacitor and emitting light sequentially by the OLED through the positive electrode of the power supply.

In some embodiments, the measuring the actual brightness of each sub-pixel unit in the corresponding pixel unit by the sensing unit, further comprising: in the sensing phase after the light-emitting phase, turning off the first scan line to turn off the second TFT and the third TFT; and turning on the second scan line to turn on the fourth TFT, so as to measure the actual brightness of each sub-pixel unit in the corresponding pixel unit by the sensing unit.

In the third aspect, the embodiment of the present invention also provides a display panel, comprising: a plurality of pixel units arranged in an array, wherein each of the pixel units comprises a plurality of sub-pixel units; and a plurality of sensing units, wherein the sub-pixel units of each of the pixel units are respectively connected to the same sensing unit; wherein each of the sensing units is used to measure an actual brightness of each of the sub-pixel units in the corresponding pixel unit and is used to perform a brightness compensation on each of the sub-pixel units according to the actual brightness, so as to make each of the sub-pixel units reaches a target brightness; wherein the sensing unit includes a photodiode, each sub-pixel unit includes an OLED and a plurality of thin film transistors, the OLED includes an organic light emitting layer, and the thin film transistors form a thin film transistor array; and wherein the photodiode is arranged between the organic light-emitting layer and the thin film transistor array, and the organic light-emitting layer emits light to the photodiode.

In some embodiments, each of the sub-pixel units includes a first thin film transistor (TFT), a second TFT, a third TFT, a first storage capacitor, and an organic light emitting diode (OLED); wherein a gate of the first TFT is respectively connected to a drain of the second TFT and a first end of the first storage capacitor; a source of the first TFT is connected to a positive electrode of the power supply; a drain of the first TFT is connected to a second end of the first storage capacitor, an anode of the OLED, and a source of the third TFT; a cathode of the OLED is connected to a negative electrode of the power supply; a gate of the second TFT and a gate of the third TFT are connected to a first scan line; a source of the second TFT is connected to a data line; and a drain of the third TFT is connected to a sensing line.

In some embodiments, the sensing unit includes a fourth TFT, a photodiode, and a second storage capacitor; wherein a gate of the fourth TFT is connected to a second scan line, a drain of the fourth TFT is connected to the sensing line, a source of the fourth TFT is connected to a first end of the photodiode, a second end of the photodiode is connected to a control line, and a first end of the second storage capacitor is connected to the sensing line.

In some embodiments, the sensing unit further includes a compensation module, which is connected to a second end of the second storage capacitor and is configured to adjust the data voltage provided from the data line to the sub-pixel unit according to the actual brightness of the sub-pixel unit, so as to make the sub-pixel unit reach the target brightness.

In some embodiments, the brightness compensation process of the display panel comprising: emitting light sequentially by sub-pixel units in each pixel unit on a time gap between the frame images displayed by the display panel and measuring the actual brightness of each sub-pixel unit in the corresponding pixel unit by the sensing unit; and performing brightness compensation on each sub-pixel unit according to the actual brightness of each sub-pixel unit measured by the sensing unit, so as to make each sub-pixel unit reach the target brightness.

In some embodiments, the emitting light sequentially by sub-pixel units in each pixel unit and measuring the actual brightness of each sub-pixel unit in the corresponding pixel unit by the sensing unit, specifically comprising: emitting light sequentially by one of the sub-pixels in each pixel unit and measuring the actual brightness of one of the sub-pixel units by the sensing unit corresponding to the pixel unit.

In some embodiments, the performing brightness compensation on each sub-pixel unit according to the actual brightness of each sub-pixel unit measured by the sensing unit, so as to make each sub-pixel unit reach the target brightness, specifically comprising: calculating a difference between the actual brightness and the target brightness of each sub-pixel unit by the compensation module, and adjusting a data voltage provided from the data line to each sub-pixel unit, so as to make the actual brightness of each sub-pixel unit reach the target brightness.

In some embodiments, the displaying frame images by the display panel, specifically comprising: in a reset phase, turning on the first scan line to turn on the second TFT and the third TFT and to reset potentials of the first terminal and the second terminal of the first storage capacitor; in the write phase, writing a data signal through the data line to turn on the first TFT and to charge the first storage capacitor; and in the light emitting phase, keeping the first TFT turning on by the coupling effect of the first storage capacitor and emitting light sequentially by the OLED through the positive electrode of the power supply.

In some embodiments, the measuring the actual brightness of each sub-pixel unit in the corresponding pixel unit by the sensing unit, further comprising: in the sensing phase after the light-emitting phase, turning off the first scan line to turn off the second TFT and the third TFT; and turning on the second scan line to turn on the fourth TFT, so as to measure the actual brightness of each sub-pixel unit in the corresponding pixel unit by the sensing unit.

In the display panel and the brightness compensation method provided by the embodiments of the present invention, multiple sub-pixel units in each pixel unit share the same sensing unit, and the normal display process and optical detection process of each pixel unit are performed separately. After each pixel unit performs normal display, the multiple sub-pixel units in each pixel unit emit light in sequence; at the same time, the sensing unit corresponding to the pixel unit respectively measures the actual brightness of each sub-pixel unit and performs brightness compensation on each sub-pixel unit according to the actual brightness, making not only the each sub-pixel unit and its brightness reach the target brightness but also the brightness of each area of the display panel become uniform. Therefore, in the OLED display panel, for the inconsistent mobility or the threshold voltage drifts of the driving transistors, or for the display unevenness or the afterimage due to the aging of the OLED, requiring the optical compensation to the display panel, the present invention could reduce the number of sensing units in the optical compensation system, simplify the manufacturing process of the display panel and reduce the manufacturing cost.

### DESCRIPTION OF DRAWINGS

FIG. 1 is a schematic diagram of the structure of a display panel in the prior art;

FIG. 2 is a schematic structural diagram of a display panel provided by an embodiment of the present invention;

FIG. 3 is a schematic structural diagram of a sub-pixel unit and a sensing unit of a display panel provided by an embodiment of the present invention;

FIG. 4 is a schematic diagram of a specific structure of a sensing unit provided by an embodiment of the present invention;

FIG. 5 is a schematic cross-sectional view of a display panel provided by an embodiment of the present invention;

FIG. 6 is a schematic structural diagram of a pixel unit and a sensing unit of a display panel provided by an embodiment of the present invention; and

FIG. 7 is an overall flowchart of a brightness compensation method of a display panel provided by an embodiment of the present invention.

### DETAILED DESCRIPTION OF EMBODIMENTS

In order to make the purpose, technical solutions and effects of this application clearer and clearer, please refer to the following drawings and examples to further describe this application in detail.

The current active-matrix organic light-emitting diode (AMOLED) panel usually uses a voltage driving method to drive the display, making a driver IC provide a voltage signal representing the gray scale. The voltage signal will be converted into the current signal of the driving transistor inside the pixel circuit, so as to drive the organic light-emitting diode (OLED) to achieve the brightness gray scale. This method has the advantages of fast driving speed and simple implementation process so is suitable for driving large-size display panels and is widely used in the industry but requires additional thin film transistors and capacitive devices to compensate for the non-uniformity of each transistor, IR drop caused by the resistance and capacitance bad, and the non-uniformity of the OLED.

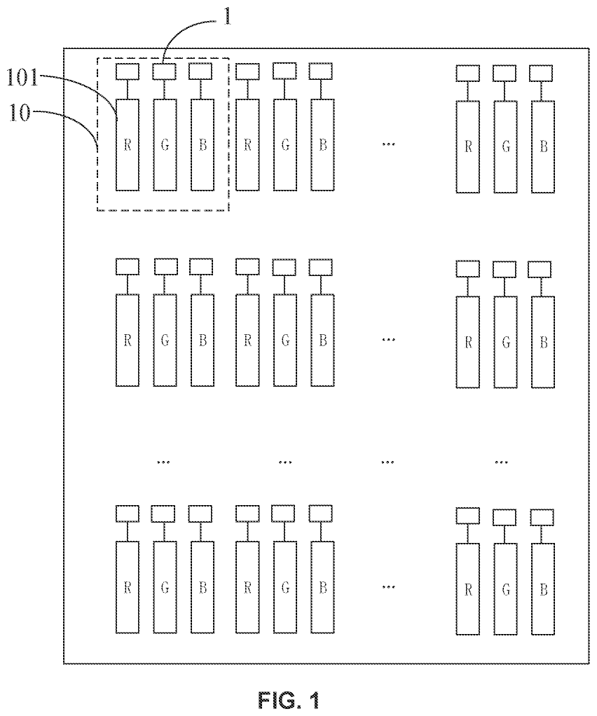

FIG. 1 is a schematic diagram of the structure of a display panel in the prior art. As shown in FIG. 1, the current AMOLED display panel generally integrates an optical compensation system. The display panel includes a plurality of pixel units 10 arranged in an array, and each pixel unit 10 includes a plurality of sub-pixel units 101 (which may be a red sub-pixel R, a green sub-pixel G, and a blue sub-pixel B), and each sub-pixel unit 101 is provided with a light emitting device such as an OLED. Specifically, the display panel sends the display data of each sub-pixel unit 101 to a timing controller, the timing controller converts the display data into a voltage signal and outputs the voltage signal to a source driver, and then the source driver provides the data voltage V_{data} through the data line Data to enable each sub-pixel unit 101 to perform a display. After each sub-pixel unit 101 completes the display, the optical compensation system uses an optical lens and a brightness measuring instrument to obtain the actual brightness of the organic light emitting diode OLED of each sub-pixel unit 101 and performs data calculation on the actual brightness and the target brightness to obtain the compensation data, stores the compensation data into the source driver chip; so that, the source driver adjusts the data voltage V_{data} provided by the data line Data to modify the brightness of each sub-pixel unit 101 and to make the brightness of each sub-pixel unit 101 reach the target brightness. In the current optical compensation system, each optical sensor 1 corresponds to only one sub-pixel unit 101. As the size of the display panel increases, the number of pixels increases sharply, that causes the number of required optical sensor 1 increases sharply as well, making the complicated manufacturing process and increased manufacturing cost of the display panel.

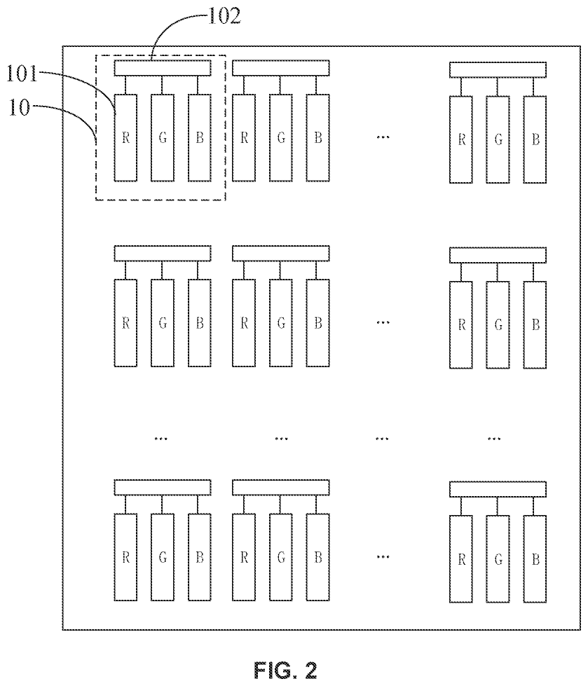

In view of this, FIG. 2 is a schematic structural diagram of a display panel provided by an embodiment of the present invention. As shown in FIG. 2, the display panel provided by the embodiment of the present invention further includes a sensing unit 102, and the multiple sub-pixel units 101 in each pixel unit 10 are respectively connected to the same sensing unit 102. Each sensing unit 102 is used to measure the actual brightness of each sub-pixel unit 101 in the corresponding pixel unit 10, and perform brightness compensation on each sub-pixel unit 101 according to the actual brightness, so that each sub-pixel unit 101 reaches the target brightness. Wherein, the target brightness refers to a defined or assigned brightness of each sub-pixel unit 101 needs to achieve according to the data signal provided by the data line Data.

It can be understood that the sensing unit 102 could be an optical sensor for measuring the brightness of each sub-pixel unit 101.

In the display panel provided by this embodiment, multiple sub-pixel units 101 in each pixel unit 10 share the same sensing unit 102, and the normal display process and optical detection process of each pixel unit 10 are performed separately. After each pixel unit 10 performs normal display, the multiple sub-pixel units 101 in each pixel unit 10 emit light in sequence; at the same time, the sensing unit 102 corresponding to the pixel unit respectively measures the actual brightness of each sub-pixel unit 101 and performs brightness compensation on each sub-pixel unit 101 according to the actual brightness, making not only each sub-pixel unit 101 reach the target brightness but also the brightness of each area of the display panel become uniform. Therefore, in the OLED display panel, for the inconsistent mobility or the threshold voltage drifts of the driving transistors, or for the display unevenness or the afterimage due to the aging of the OLED, requiring the optical compensation to the display panel, the present invention could reduce the number of sensing units 102 in the optical compensation system, simplify the manufacturing process of the display panel and reduce the manufacturing cost.

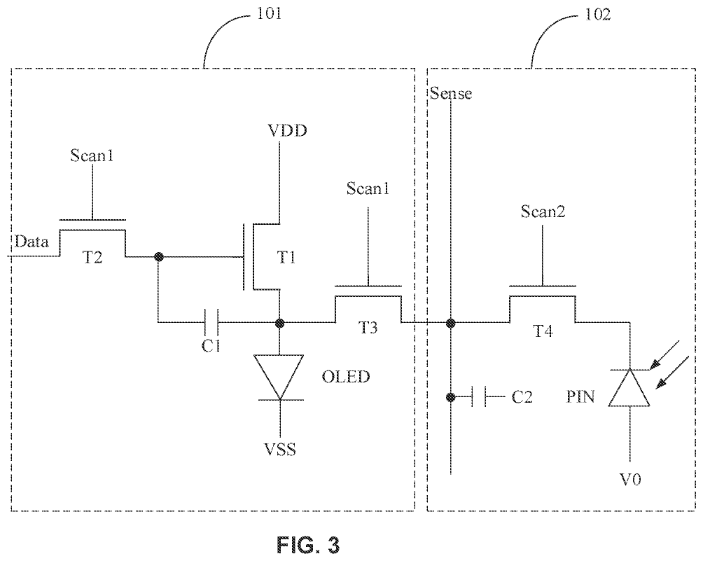

Based on the above embodiment, FIG. 3 is a schematic structural diagram of a sub-pixel unit 101 and a sensing unit 102 of a display panel provided by an embodiment of the present invention. FIG. 3 discloses an exemplary structure of the sub-pixel unit 101 and the sensing unit 102. Each sub-pixel unit 101 includes a first thin film transistor (TFT) T1, a second TFT T2, a third TFT T3, a first storage capacitor C1 and an organic light-emitting diode OLED. Wherein, a gate of the first TFT T1 is respectively connected to a drain of the second TFT T2 and a first end of the first storage capacitor C1; a source of the first TFT T1 is connected to a positive electrode V_{DD} of the power supply; a drain of the first TFT T1 is connected to a second end of the first storage capacitor C1, an anode of the organic light-emitting diode OLED, and a source of the third TFT T3; a cathode of the organic light-emitting diode OLED is connected to a negative electrode Vₛₛ of the power supply; a gate of the second TFT T2 and a gate of the third TFT T3 are connected to a first scan line Scan₁; a source of the second TFT T2 is connected to a data line Data; and a drain of the third TFT T3 is connected to a sensing line Sense.

Please continue to refer to FIG. 3, the sensing unit 102 includes a fourth TFT T4, a photodiode PIN, and a second storage capacitor C2; wherein a gate of the fourth TFT T4 is connected to a second scan line Scan2, a drain of the fourth TFT T4 is connected to the sensing line Sense, a source of the fourth TFT T4 is connected to the drain of the third TFT T3 of each sub-pixel unit 101 corresponding to the sensing unit 102, a drain of the fourth TFT T4 is connected to the first end of the photodiode PIN, a second end of the photodiode PIN is connected to the control line V0 (the control line V0 makes the photodiode PIN in a reverse bias state) and a first end of the second storage capacitor C2 is connected to the sensing line Sense.

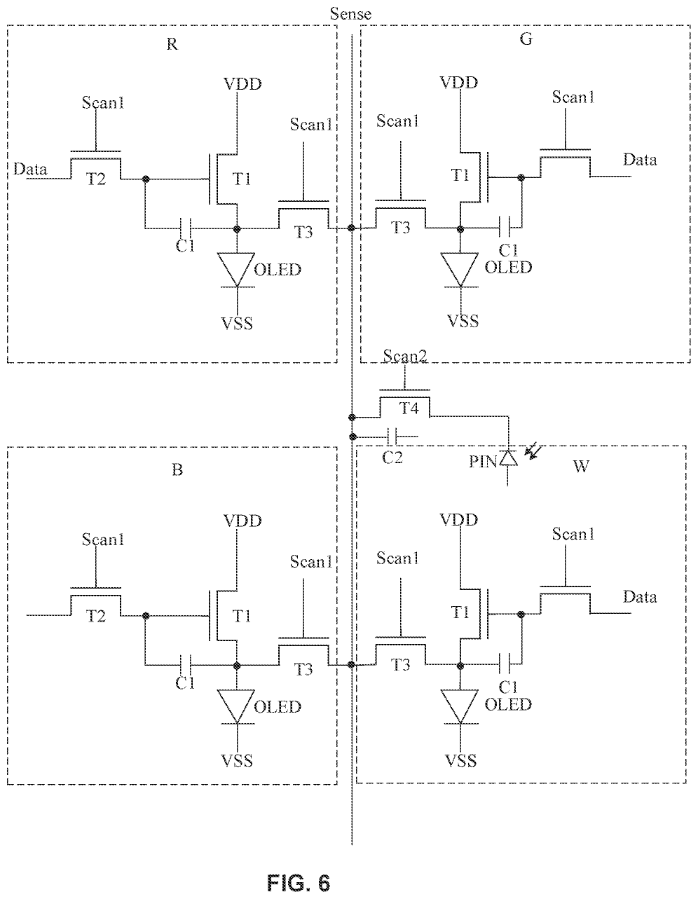

It should be noted that the pixel driving circuits in every two adjacent sub-pixel units 101 located in the same row can be mirrored. As shown in FIG. 6, each two adjacent sub-pixel units 101 in the same row can share the same sensing line Sense, so as to reduce the number of sensing lines Sense.

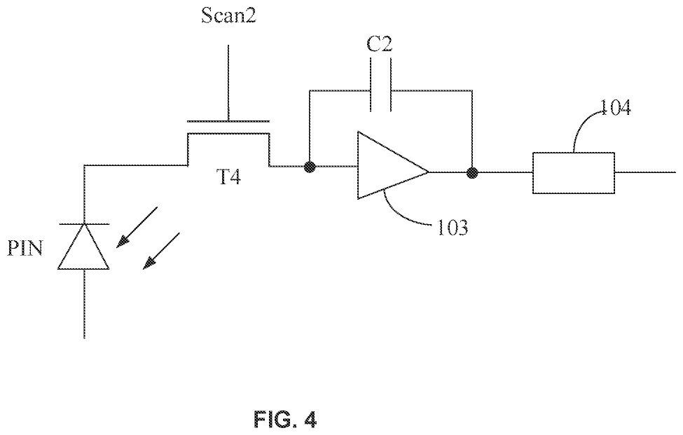

Furthermore, FIG. 4 is a schematic diagram of a specific structure of the sensing unit 102 provided by an embodiment of the present invention. As shown in FIG. 4, the sensing unit 102 further includes an operational amplifier 103, which connects the second storage capacitor C2 in parallel to form an integrating amplifier circuit. After the photodiode PIN is irradiated by the light emitted from the organic light-emitting diode OLED in the sub-pixel unit 101 for a certain period of time, the integrating amplifier circuit converts the current formed by the charge generated by the photodiode PIN into a voltage signal and inputs the voltage signal to the timing controller, and the timing controller controls the source driver to adjust the data line Data according to the voltage signal to provide the data voltage Vdata to the sub-pixel unit 101 when the sub-pixel unit 101 displays; thus, the brightness of each sub-pixel unit 101 is compensated, and the brightness of each sub-pixel unit 101 reaches the target brightness.

Moreover, please refer to FIG. 4, the sensing unit further includes a compensation module 104, which is connected to the second end of the second storage capacitor C2, is configured to adjust the data voltage Vdata provided by the data line Data to the sub-pixel unit 101 according to the actual brightness of the sub-pixel unit 101, so that the sub-pixel unit 101 reaches the target brightness. It can be understood that the compensation module 104 is connected to the source driver and transmits the compensation data to the source driver, and then the source driver adjusts the data voltage Vdata provided by the data line Data.

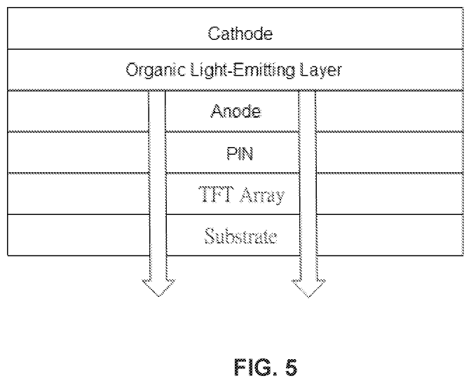

FIG. 5 is a schematic cross-sectional view of a display panel provided by an embodiment of the present invention. As shown in FIG. 3 and FIG. 5, the OLED display panel includes a substrate, a TFT array, an anode, an organic light-emitting layer, a cathode, and an encapsulation layer from bottom to top; wherein, the anode, the organic light-emitting layer and the cathode constitute an OLED. In this embodiment, the photodiode PIN is arranged between the organic light-emitting layer and the thin film transistor array, and the OLED adopts a bottom emission mode, so the organic light-emitting layer emits light downward to the photodiode PIN.

The display panel provided by this embodiment makes the photodiode PIN of the sensing unit 102 arrange between the organic light-emitting layer and the thin film transistor array and makes the OLED adopt a bottom emission mode, so the organic light-emitting layer emits light downward to the photodiode PIN; as a result, the photodiode PIN detects the luminous intensity of the OLED, that is, the actual brightness of the sub-pixel unit 101. Compared with the prior art, in order to simplify the process and reduce the cost, the photodiode PIN and the organic light-emitting layer are printed on the same layer; in the prevent embodiment, the photosensitive diode PIN of the sensing unit 102 is disposed between the organic light-emitting layer of the OLED and the thin film transistor array, so as to increase the photosensitive area and greatly improve the photosensitive result.

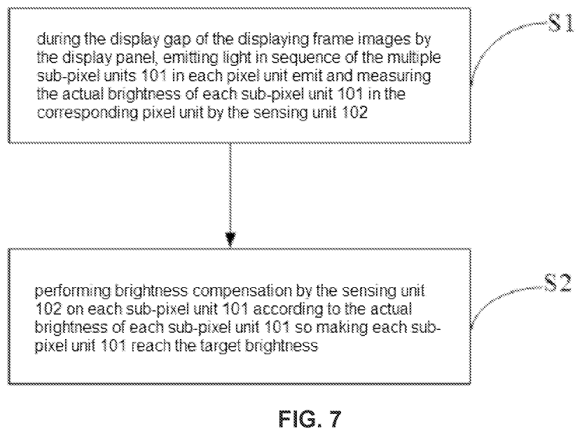

FIG. 7 is an overall flowchart of a brightness compensation method of a display panel provided by an embodiment of the present invention. As shown in FIG. 7, an embodiment of the present invention also provides a brightness compensation method of a display panel, including: Step S1: during the displaying gap of the frame images displayed by the display panel, emitting light in sequence of the multiple sub-pixel units 101 in each pixel unit emit and measuring the actual brightness of each sub-pixel unit 101 in the corresponding pixel unit by the sensing unit 102; and Step S2: performing brightness compensation by the sensing unit 102 on each sub-pixel unit 101 according to the actual brightness of each sub-pixel unit 101 so making each sub-pixel unit 101 reach the target brightness.

It should be noted that when the display panel displays each frame of image, it includes the normal display period (V_{active}) and the vertical blanking period (V_{blank}). The vertical blanking period refers to the time interval for the display panel to return from the lower right corner of the image to the upper left corner of the image after scanning one frame and to start scanning of a new frame. In this embodiment, the normal display process and the optical detection process of each pixel unit are performed separately, and the optical detection process is performed during the vertical blanking period.

It should also be noted that in this embodiment, multiple sub-pixel units 101 in each pixel unit share the same sensing unit 102, that is, each sensing unit 102 is used to measure the actual brightness of all sub-pixel units 101 in a corresponding pixel unit. It can be understood that when the sensing unit 102 measures the actual brightness of a sub-pixel unit 101, among the pixel units where the sub-pixel unit 101 is located, only the sub-pixel unit 101 emits light, and none of the other sub-pixel units 101 emit light, so that the sensing unit 102 can accurately sense the actual brightness of the sub-pixel unit 101. Since each vertical blanking period is short, generally only one sub-pixel unit 101 can be sensed, therefore, if each pixel unit includes N sub-pixel units 101 (N is a positive integer), it is necessary to make the N sub-pixel units 101 in each pixel unit emit sequentially, to measure the actual brightness of the N sub-pixel units 101 in the corresponding pixel unit by the sensing unit 102 as the actual brightness of all the sub-pixel units 101, to compare the actual brightness of all sub-pixels with their target brightness, and finally to add the difference between the target brightness and the actual brightness as compensation data to the data signal in the next normal display period for adjusting the data signal of the next frame of image for display; that is, the data signal of the normal display stage of each frame of image is obtained by superimposing the actual brightness and the difference between the target brightness and the actual brightness.

The brightness compensation method of the display panel provided in this embodiment separates the normal display process and the optical detection process of each pixel unit, makes the multiple sub-pixel units 101 in each pixel unit emit light in sequence after the normal display of each pixel unit, measures the actual brightness of the multiple sub-pixel units 101 in the pixel unit by the corresponding sensing unit 102 respectively, and performs brightness compensation on each sub-pixel unit 101 according to the actual brightness, so make each sub-pixel unit 101 reach the target brightness to uniform the brightness of each area of the display panel, reducing the driving transistors or threshold voltage drift of the OLED display panel due to the inconsistent mobility or the unevenness or image retention due to the aging of OLED.

It should be noted that, in step S1, the emitting light in sequence of the multiple sub-pixel units 101 in each pixel unit and measuring the actual brightness of each sub-pixel unit 101 in the corresponding pixel unit by the sensing unit 102, which specifically includes: emitting light sequentially by one of the sub-pixels in each pixel unit 101 and measuring the actual brightness of one of the sub-pixel units 101 by the sensing unit 102 corresponding to the pixel unit.

It should be noted that, in step S2: the performing brightness compensation on each sub-pixel unit 101 according to the actual brightness of each sub-pixel unit 101 measured by the sensing unit 102, so that each sub-pixel unit 101 reaches the target brightness, specifically comprising: calculating a difference between the actual brightness and the target brightness of each sub-pixel unit 101 by the compensation module 104, and adjusting a data voltage V_{data} provided from the data line Data to each sub-pixel unit 101, so that the actual brightness of each sub-pixel unit 101 reaches the target brightness.

Based on the above embodiment, in step S1, the displaying frame images by the display panel, specifically comprising: turning on the first scan line Scan1, in a reset phase, to turn on the second TFT T2 and the third TFT T3 and to reset potentials of the first terminal and the second terminal of the first storage capacitor C1; writing a data signal Data in the write phase through the data line to turn on the first TFT T1 and to charge the first storage capacitor C1; and keeping the first TFT T1 turning on in the light emitting phase by the coupling effect of the first storage capacitor C1 and emitting light by the OLED through the positive electrode V_{DD} of the power supply.

Specifically, the normal display period of each frame of image includes a reset phase, a writing phase, and a light emitting phase. First, in the reset phase: turning on the first scan line Scan1 to turn on the second thin film transistor T2 and the third thin film transistor T3, and the potentials of the first terminal and the second terminal of the first storage capacitor C1 are reset to 0 through the data line Data and the sensing line Sense respectively; second, in the writing phase, writing data signal by the data line Data through the second thin film transistor T2 so turning on the first thin film transistor T1 and charging the first storage capacitor C1; finally, in the light emitting phase, emitting light from OLED by the positive electrode V_{DD} of the power supply through the first thin-film transistor T1 and making the gate-source voltage difference V_{gs} of the first thin film transistor T1 unchanged due to the coupling effect of the first storage capacitor C1, so as to keep the first thin film transistor T1 being open.

Based on the above embodiment, in step S1, the measuring the actual brightness of each sub-pixel unit 101 in the corresponding pixel unit 10 by the sensing unit 102, further comprising: turning off the first scan line Scan1, in the sensing phase after the light-emitting phase, to turn off the second TFT T2 and the third TFT T3; and turning on the second scan line Scan2 to turn on the fourth TFT T4, so as to measure the actual brightness of each sub-pixel unit 101 in the corresponding pixel unit 10 by the sensing unit 102.

Specifically, in the gap between the normal display period of two consecutive frames of images, that is, the vertical blanking and sensing phase, the first scan line Scan1 is turned off to turn off the second TFT T2 and the third TFT T3, and the second scan line Scan2 is turned on to turn on the fourth TFT T4, so as to measure to measure the actual brightness of each sub-pixel unit 101 in the corresponding pixel unit by the sensing unit 102. If each vertical blanking period can only measure the actual brightness of one sub-pixel unit 101 in each pixel unit, and each pixel unit includes N sub-pixel units 101 (N is a positive integer), it is necessary to make the N sub-pixel units 101 in each unit emit light in sequence during the displaying gap of at least N frames of images, (N vertical blanking periods) and to measure the actual brightness of the N sub-pixel units 101 in the corresponding pixel unit by the sensing unit 102, so as to measure the actual brightness of all the sub-pixel units 101.

FIG. 6 is a schematic structural diagram of a pixel unit and a sensing unit 102 of a display panel provided by an embodiment of the present invention. As shown in FIG. 6, the following takes each pixel unit including red sub-pixels, green sub-pixels, blue sub-pixels, and white sub-pixels forming a square-shaped structure as an example to describe in detail the working process of the brightness compensation method. Wherein, the red sub-pixel and the green sub-pixel are in the same row, the blue sub-pixel and the white sub-pixel are in the same row, the red sub-pixel and the blue sub-pixel are in the same column, and the green sub-pixel and the white sub-pixel are in the same column.

Specifically, the sub-pixel units 101 located in the same row share the same scan line, and the sub-pixel units 101 located in the same column share the same column data line Data; after the displaying frame images by the display panel, in the vertical blanking period after the normal display period of any four frames of images (may be continuous or discontinuous four frames of images), the sensing unit 102 respectively measures the actual brightness of the red sub-pixel, green sub-pixel, blue sub-pixel, and white sub-pixel in its corresponding pixel unit, and performs brightness compensation on each sub-pixel unit 101 according to the actual brightness, so as to make each sub-pixel unit 101 reach the target brightness.

For example, in the vertical blanking period of any frame of image, emitting the red sub-pixels in each pixel unit but not the green sub-pixels, blue sub-pixels and white sub-pixels, measuring the actual brightness of the red sub-pixel by the sensing unit 102, comparing the actual brightness with the target brightness that the red sub-pixel needs to achieve by the data voltage V_{data} provided by the data line Data to the red sub-pixel during the normal display period of the current frame image, calculating the difference between the actual brightness and the target brightness, and then adjusting the data signal that the image data line Data of the next frame providing to the red sub-pixel according to the difference, so that the actual brightness of the red sub-pixel reaches the target brightness.

It should be noted that in each vertical blanking period. It should be noted that in each field blanking period, the sensing unit 102 can measure the actual brightness of the sub-pixel units 101 of the same color in each pixel unit, and can also measure the actual brightness of the sub-pixel units 101 of different colors in each pixel unit, as long as the actual brightness of each sub-pixel unit 101 is measured during multiple vertical blanking periods.

It is understandable that those of ordinary skill in the art can make equivalent substitutions or changes according to the technical solutions of the present application and its inventive concept, but all these changes or replacements shall fall within the protection scope of the appended claims of this application.

What is claimed is:

1. A display panel, comprising:
a plurality of pixel units arranged in an array, wherein each of the pixel units comprises a plurality of sub-pixel units; and
a plurality of sensing units, wherein the sub-pixel units of each of the pixel units are respectively connected to the same sensing unit;
wherein each of the sensing units is used to measure an actual brightness of each of the sub-pixel units in the corresponding pixel unit and is used to perform a brightness compensation on each of the sub-pixel units according to the actual brightness, so as to make each of the sub-pixel units reaches a target brightness.

2. The display panel according to claim 1, wherein each of the sub-pixel units includes a first thin film transistor (TFT), a second TFT, a third TFT, a first storage capacitor, and an organic light emitting diode (OLED);
wherein a gate of the first TFT is respectively connected to a drain of the second TFT and a first end of the first storage capacitor; a source of the first TFT is connected to a positive electrode of the power supply; a drain of the first TFT is connected to a second end of the first storage capacitor, an anode of the OLED, and a source of the third TFT; a cathode of the OLED is connected to a negative electrode of the power supply; a gate of the second TFT and a gate of the third TFT are connected to a first scan line; a source of the second TFT is connected to a data line; and a drain of the third TFT is connected to a sensing line.

3. The display panel according to claim 2, wherein the sensing unit includes a fourth TFT, a photodiode, and a second storage capacitor;
wherein a gate of the fourth TFT is connected to a second scan line, a drain of the fourth TFT is connected to the sensing line, a source of the fourth TFT is connected to a first end of the photodiode, a second end of the photodiode is connected to a control line, and a first end of the second storage capacitor is connected to the sensing line.

4. The display panel according to claim 3, wherein the sensing unit further includes a compensation module, which is connected to a second end of the second storage capacitor and is configured to adjust the data voltage provided from the data line to the sub-pixel unit according to the actual brightness of the sub-pixel unit, so as to make the sub-pixel unit reach the target brightness.

5. The display panel according to claim 3, wherein the OLED includes an organic light emitting layer; wherein the photodiode is disposed between the organic light emitting layer and a TFT array, and the organic light emitting layer emits light to the photodiode.

6. The display panel according to claim 1, wherein the display panel is an OLED display panel.

7. A brightness compensation method of a display panel, used in the display panel of claim 1, comprising:
emitting light sequentially by sub-pixel units in each pixel unit on a gap between the frame images displayed by the display panel and measuring the actual brightness of each sub-pixel unit in the corresponding pixel unit by the sensing unit; and
performing brightness compensation on each sub-pixel unit according to the actual brightness of each sub-pixel unit measured by the sensing unit, so as to make each sub-pixel unit reach the target brightness.

8. The brightness compensation method of a display panel according to claim 7, wherein the emitting light sequentially by sub-pixel units in each pixel unit and measuring the actual brightness of each sub-pixel unit in the corresponding pixel unit by the sensing unit, specifically comprising:
emitting light sequentially by one of the sub-pixels in each pixel unit and measuring the actual brightness of one of the sub-pixel units by the sensing unit corresponding to the pixel unit.

9. The brightness compensation method of a display panel according to claim 7, wherein performing brightness compensation on each sub-pixel unit according to the actual brightness of each sub-pixel unit measured by the sensing unit, so as to make each sub-pixel unit reach the target brightness, specifically comprising:
calculating a difference between the actual brightness and the target brightness of each sub-pixel unit by the compensation module and adjusting a data voltage provided from the data line to each sub-pixel unit, so as to make the actual brightness of each sub-pixel unit reach the target brightness.

10. The brightness compensation method of a display panel according to claim 7, wherein the displaying frame images by the display panel, specifically comprising:
turning on the first scan line, in a reset phase, to turn on the second TFT and the third TFT and to reset potentials of the first terminal and the second terminal of the first storage capacitor;
writing a data signal, in the write phase, through the data line to turn on the first TFT and to charge the first storage capacitor; and
keeping the first TFT turning on, in the light emitting phase, by the coupling effect of the first storage capacitor and emitting light by the OLED through the positive electrode of the power supply.

11. The brightness compensation method of a display panel according to claim 10, wherein the measuring the actual brightness of each sub-pixel unit in the corresponding pixel unit by the sensing unit, further comprising:
turning off the first scan line, in the sensing phase after the light-emitting phase, to turn off the second TFT and the third TFT; and
turning on the second scan line to turn on the fourth TFT, so as to measure the actual brightness of each sub-pixel unit in the corresponding pixel unit by the sensing unit.

12. A display panel, comprising:
a plurality of pixel units arranged in an array, wherein each of the pixel units comprises a plurality of sub-pixel units; and
a plurality of sensing units, wherein the sub-pixel units of each of the pixel units are respectively connected to the same sensing unit;
wherein each of the sensing units is used to measure an actual brightness of each of the sub-pixel units in the corresponding pixel unit and is used to perform a brightness compensation on each of the sub-pixel units according to the actual brightness, so as to make each of the sub-pixel units reaches a target brightness;
wherein the sensing unit includes a photodiode, each sub-pixel unit includes an OLED and a plurality of thin film transistors, the OLED includes an organic light emitting layer, and the thin film transistors form a thin film transistor array; and
wherein the photodiode is arranged between the organic light-emitting layer and the thin film transistor array, and the organic light-emitting layer emits light to the photodiode.

13. The display panel according to claim 12, wherein each of the sub-pixel units includes a first thin film transistor (TFT), a second TFT, a third TFT, a first storage capacitor, and an organic light emitting diode (OLED);
wherein a gate of the first TFT is respectively connected to a drain of the second TFT and a first end of the first storage capacitor; a source of the first TFT is connected to a positive electrode of the power supply; a drain of the first TFT is connected to a second end of the first storage capacitor, an anode of the OLED, and a source of the third TFT; a cathode of the OLED is connected to a negative electrode of the power supply; a gate of the second TFT and a gate of the third TFT are connected to a first scan line; a source of the second TFT is connected to a data line; and a drain of the third TFT is connected to a sensing line.

14. The display panel according to claim 13, wherein the sensing unit includes a fourth TFT, a photodiode, and a second storage capacitor;
wherein a gate of the fourth TFT is connected to a second scan line, a drain of the fourth TFT is connected to the sensing line, a source of the fourth TFT is connected to a first end of the photodiode, a second end of the photodiode is connected to a control line, and a first end of the second storage capacitor is connected to the sensing line.

15. The display panel according to claim 14, wherein the sensing unit further includes a compensation module, which is connected to a second end of the second storage capacitor and is configured to adjust the data voltage provided from the data line to the sub-pixel unit according to the actual brightness of the sub-pixel unit, so as to make the sub-pixel unit reach the target brightness.

16. The display panel according to claim 12, wherein a brightness compensation process of the display panel comprising:
emitting light sequentially by sub-pixel units in each pixel unit on a gap between the frame images displayed by the display panel and measuring the actual brightness of each sub-pixel unit in the corresponding pixel unit by the sensing unit; and
performing brightness compensation on each sub-pixel unit according to the actual brightness of each sub-pixel unit measured by the sensing unit, so as to make each sub-pixel unit reach the target brightness.

17. The display panel according to claim 16, wherein the emitting light sequentially by sub-pixel units in each pixel unit and measuring the actual brightness of each sub-pixel unit in the corresponding pixel unit by the sensing unit, specifically comprising:
emitting light sequentially by one of the sub-pixels in each pixel unit and measuring the actual brightness of one of the sub-pixel units by the sensing unit corresponding to the pixel unit.

18. The display panel according to claim 16, wherein the performing brightness compensation on each sub-pixel unit according to the actual brightness of each sub-pixel unit measured by the sensing unit, so as to make each sub-pixel unit reach the target brightness, specifically comprising:
calculating a difference between the actual brightness and the target brightness of each sub-pixel unit by the compensation module, and adjusting a data voltage provided from the data line to each sub-pixel unit, so as to make the actual brightness of each sub-pixel unit reach the target brightness.

19. The display panel according to claim 16, wherein the displaying frame images by the display panel, specifically comprising:
turning on the first scan line, in a reset phase, to turn on the second TFT and the third TFT and to reset potentials of the first terminal and the second terminal of the first storage capacitor;
writing a data signal, in the write phase, through the data line to turn on the first TFT and to charge the first storage capacitor; and
keeping the first TFT turning on, in the light emitting phase, by the coupling effect of the first storage capacitor and emitting light by the OLED through the positive electrode of the power supply.

20. The display panel according to claim 19, wherein the measuring the actual brightness of each sub-pixel unit in the corresponding pixel unit by the sensing unit, further comprising:
turning off the first scan line, in the sensing phase after the light-emitting phase, to turn off the second TFT and the third TFT; and
turning on the second scan line to turn on the fourth TFT, so as to measure the actual brightness of each sub-pixel unit in the corresponding pixel unit by the sensing unit.
